(19) United States
(12) Patent Application Publication
(10) Pub. No.: US 2004/0139924 A1
(43) Pub. Date: Jul. 22, 2004

(54) Animal pen system

(76) Inventor: Lawrence E. Hannon, Reno, NV (US)

Correspondence Address: SIERRA PATENT GROUP, LTD., P O BOX 6149, STATELINE, NV, 89449, US

(21) Appl. No.: 10/692,452

(22) Filed: Oct. 22, 2003

Related U.S. Application Data
(60) Provisional application No. 60/442,594, filed on Jan. 22, 2003.

(51) Int. Cl. A01K 1/02

(52) U.S. Cl. 119/502

(57) ABSTRACT

The disclosed device is directed towards an animal pen system including a body having a top surface and a bottom surface opposite the top surface. The body is flexible and the body defines a support wall proximate a perimeter of the body. The support wall is configured to support a pen wall disposed on the top surface of the body. The support wall is configured to demountably couple to the pen wall.

### PRIORITY CLAIM

This application claims priority to Provisional Application No. 60/442,594 filed with the United States Patent and Trademark Office on Jan. 22, 2003.

### BACKGROUND

The present disclosure relates to the field of animal enclosures. In particular, the disclosure relates to an animal pen system and support structure.

Pets, such as dogs, require containment within pens to protect valuables in homes and provide a safe location for a pet to exercise. The pens are typically vertical walls constructed of webbing such as plastic, steel bar, and the like. The walls are mounted on the surface of the ground, or if indoors, set on top of the floor of a home. The pen acts as a barrier to limit the travel of the pet to a particular area. The pen does not shield or protect the floor of a home. Thus, damage to the floor can occur from the pet. Puppies that are teething can scratch, and even gnaw the flooring surface causing damage. The surface of the flooring is also vulnerable to vomit, urine, or fecal matter. The use of the pens outdoors leaves the ground exposed to the wear of the pet. The ground can be defoliated, become muddy, and even be vulnerable to trenches and holes being dug. The pet can become dirty, and if in colder climates, be exposed to the cold earth.

What is needed in the art is a protective surface that is compatible with and provides a support for animal pens.

### SUMMARY

The disclosed device is directed towards an animal pen system including a body having a top surface and a bottom surface opposite the top surface. The body is flexible and the body defines a support wall proximate a perimeter of the body. The support wall is configured to support a pen wall disposed on the top surface of the body. The support wall is configured to demountably couple to the pen wall.

An alternate embodiment is disclosed comprising a pen platform having a top surface and a bottom surface opposite the top surface. The platform is configured to fold along at least one fold line defined in the pen platform. The pen platform defines a wall portion formed from the pen platform. The wall portion extends from the top surface distally from the bottom surface. The wall portion is configured to enclose a pen wall about a base of said pen wall. The wall portion is configured to extend along the pen wall. A coupling element is demountably coupled to the wall portion and the pen wall. At least one handle is disposed on the bottom surface. The pen platform is configured to encase the pen wall for transportation of tile pen platform and the pen wall.

A method of using an animal pen system is disclosed. The method includes deploying a pen platform having a top surface and a bottom surface opposite the top surface. The platform is configured to fold along at least one fold line defined in the pen platform. The pen platform defines a wall portion formed from the pen platform. The wall portion extends from the top surface distally from the bottom surface. The wall portion is configured to enclose a pen wall about a base of the pen wall. The wall portion is configured to extend along the pen wall. The method includes mounting the pen wall to the top surface of the pen platform. The method includes coupling the pen wall to the wall portion, wherein the wall portion encloses the pen wall about the base of the pen wall. The pen wall is prevented from moving along the top surface.

### BRIEF DESCRIPTION OF THE DRAWINGS

In the drawings:

FIG. 1 is a perspective view of an exemplary animal pen system.

FIG. 2 is a bottom view of an exemplary animal pen platform.

FIG. 3 is a top view of exemplary animal pen platform.

FIG. 4 illustrates an exemplary coupling member.

FIG. 5 is a top view of exemplary animal pen platform.

FIG. 6 is a top view of exemplary animal pen platform.

FIG. 7 is a partial cutaway side view of an exemplary animal pen system.

### DETAILED DESCRIPTION

Persons of ordinary skill in the art will realize that the following disclosure is illustrative only and not in any way limiting. Other embodiments of the invention will readily suggest themselves to such skilled persons having the benefit of this disclosure.

The disclosure describes an animal pen system. The animal pen system includes a pen platform configured to support a pen wall. The pen wall extends upward from the pen platform to enclose a volume or pen. The pen platform includes a top surface forming a wall portion and a bottom surface opposite the top surface. The pen wall mounts to the top surface at a base of the pen wall. The pen platform is flexible and can fold along at least one fold line and in preferred embodiments can fold along many fold lines. The pen platform wall portion encloses the pen wall along the base of the pen wall. A coupling element couples the pen platform to the pen wall. At least one handle is disposed on the bottom surface to facilitate the pen platform forming a carrying case enclosing the pen wall for transportation of the pen platform and pen wall.

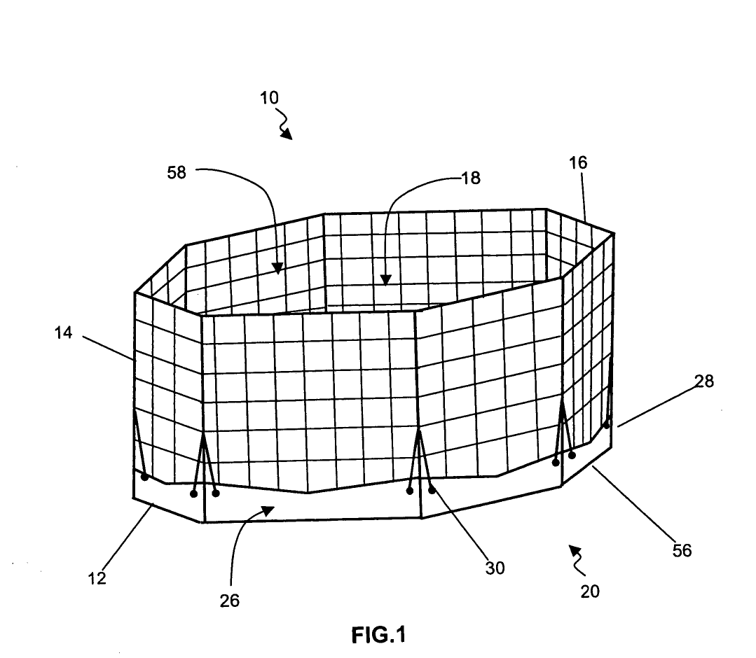

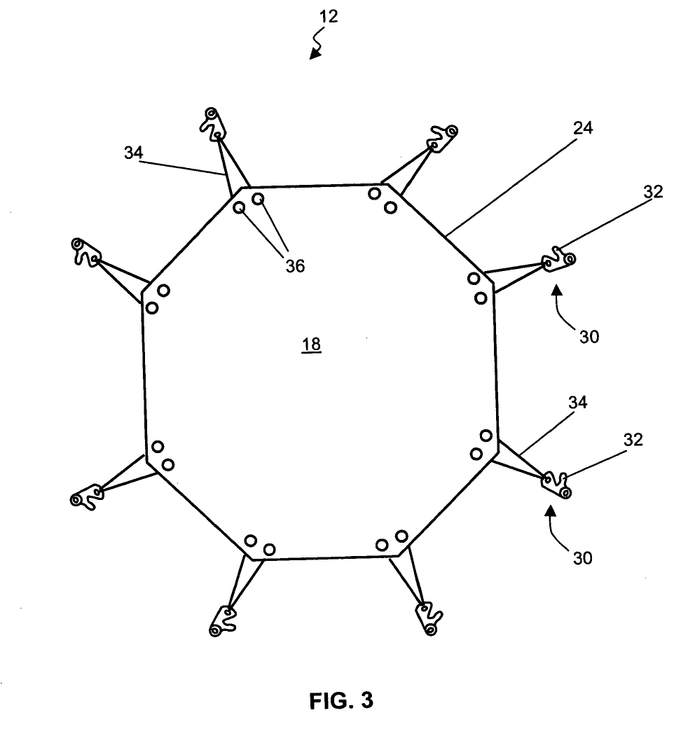

Referring to FIGS. 1, 2 and 3, the animal pen system 10 is illustrated. The animal pen system 10 includes a pen platform (or simply body) 12 that supports a pen wall 14. The pen platform 12 includes a top (or top surface) 18 and a bottom (or bottom surface) 20 opposite the top surface 18. The top surface 18 can be substantially planar and devoid of features that may be snagged or chewed by an animal. The bottom surface 20 can include a handle 22 that can be formed in the pen platform 12 or coupled to the pen platform 12. The body 12 is defined by a perimeter 24 that defines the outer boundary of the body 12. The body 12 can be a flexible material. The body 12 can include rigid portions and flexible portions (not shown). In an exemplary embodiment, the body 12 comprises a woven material having water resistant components. The body 12 can be formed into planar, convex, concave and other contours to enhance the capabilities of the body to handle liquids, such as, rain, water and urine. For example, for an outdoor application the body 12 can have a sloping contour that sheds rainwater and urine away from the top surface 18. In another exemplary embodiment, the body 12 can be concave such that the top surface contains urine, for indoor use of the animal pen system 10. The body 12 can also incorporate materials that absorb liquids or allow liquids to pass through the body 12 but be contained.

The body 12 defines a support wall (or simply a wall portion) 26 that extends from the top surface 18. The wall portion 26 encloses the pen wall 16 proximate a base 28 of the pen wall 16. The wall portion 26 encircles the pen wall 16 such that the pen wall 16 cannot slide on the top surface 18. The wall portion 26 can function to enhance the pen wall 16 in order to contain materials, such as pet food, so as to prevent the materials from spilling outside the animal pen system 10. The wall portion 26 can partially enclose the pen wall proximate the perimeter 24.

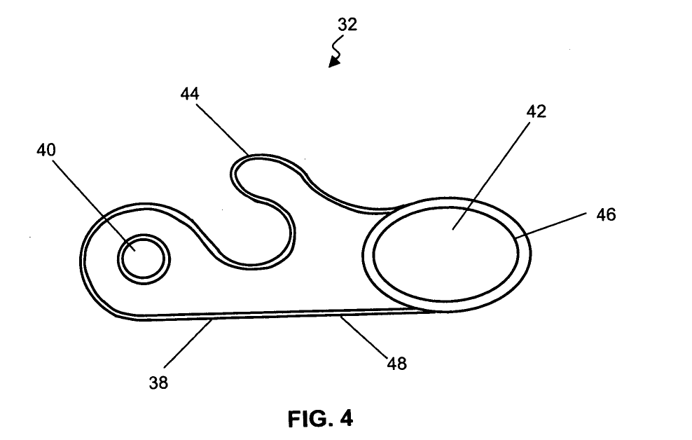

At least one attachment element (or coupling member) 30 is coupled to the pen wall 16 and platform 12. In a preferred embodiment, the coupling member 30 couples the wall portion 26 to the pen wall 16. In an exemplary embodiment, the coupling member 30 can include a hook 32 and cord 34. (See FIG. 4) The hook 32 is configured to attach to the pen wall 16. The cord 34 can be coupled to the hook 32 and the body 12 through cord mounts 36 formed in the body 12. The cord 34 and hook 32 can be biased or have tensioning elements (not shown) to enhance the coupling between the body 12 and the pen wall 16. Other elements can be employed for use as the coupling member 30, hook and loop fasteners, rubber bungy, twist ties, chain, rope, and the like.

Referring to FIG. 4, the hook 32 includes a hook body 38 having a first receiver 40 and a second receiver 42 at opposite ends thereof. A hook portion 44 is formed between the first receiver 40 and second receiver 42. The hook portion 44 is configured to couple to the pen wall. The first receiver 40 is configured to couple to the cord 34 and the second receiver 42 is configured to receive fingers for griping the hook 32. The second receiver 42 includes a receiver rim 46 that includes a raised rim (or lip) around the periphery of the second receiver 42. A body rim 48 can also be formed at the outer periphery of the hook body 38 to reinforce and strengthen the hook body 38.

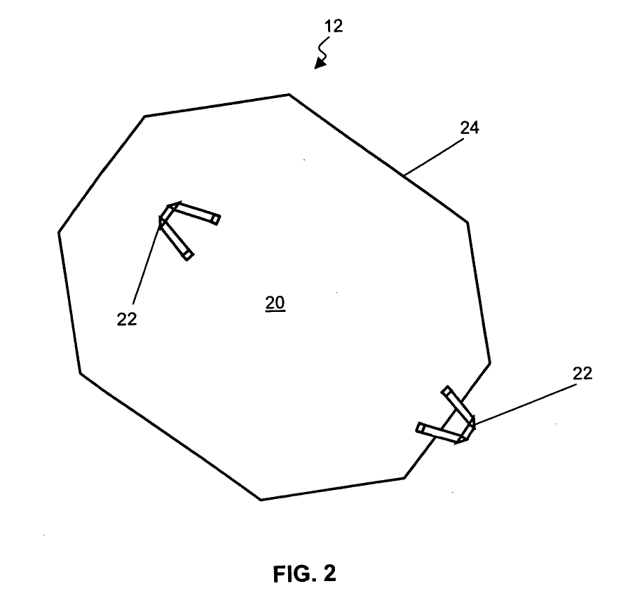

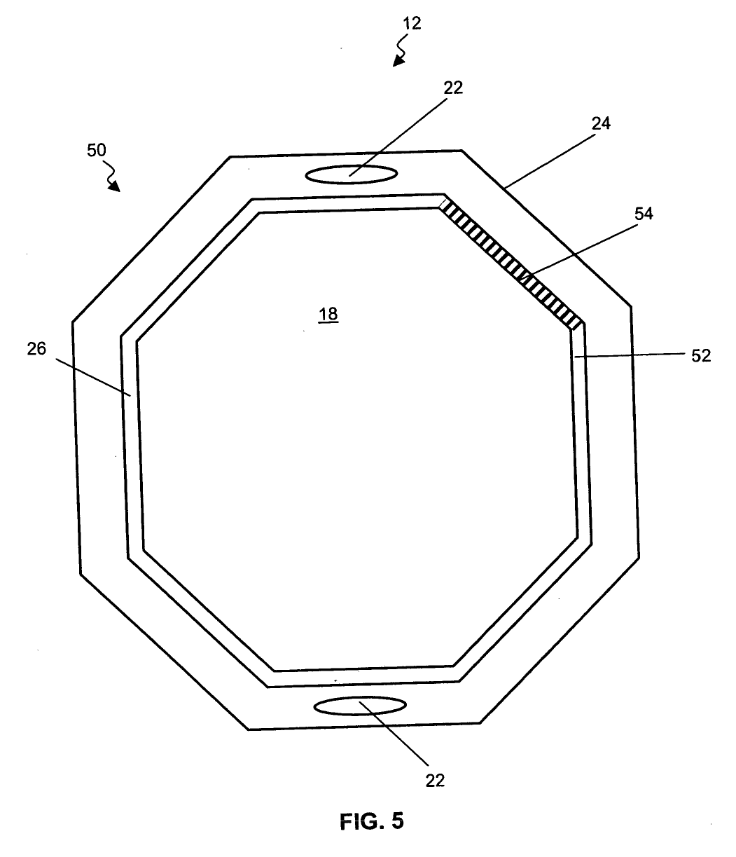

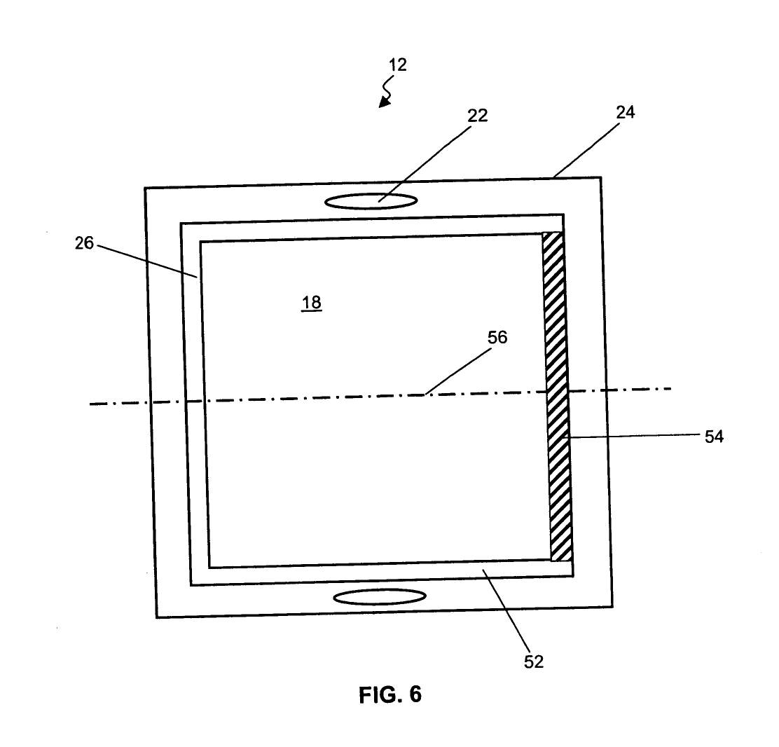

Referring also to FIGS. 5 and 6, an alternate exemplary embodiment of the animal pen system platform 12 is illustrated. The platform 12 can be more rigid in form having a predefined shape 50, such as an eight-sided polygon around the perimeter 24. The wall portion 26 can be formed in the platform 12 as a groove 52 or a ridge 54 formed in the body 12. The wall portion 26 is configured to perform the same structural and operational functions as in the previous exemplary embodiment. The handle 22 can be formed in the platform 12 as well as disposed on the bottom 20 as in FIG. 2. At least one fold line 56 can be formed in the platform 12 to enable the platform 12 to be flexible and deployable. The fold line 56 can be employed along the base 28 of the pen wall 16 to enhance the coupling between the pen wall 16 and the body 12. Multiple fold lines 56 can be employed in the platform 12 to create a variety of shapes as well as to adapt the platform 12 to various pen wall 16 designs, thereby the pen wall 16 can form a pen volume (or simply pen) 58 to contain the animals (not shown).

The pen wall 16 can include doors and slots (not shown) for egress and can be formed from webbing, expanded material, screen, bars, fence and the like. The pen wall 16 can be solid or open celled. The pen wall 16 can be assembled by sections, as shown in FIG. 1 or the pen wall 16 can be a continuous roll. The pen wall 16 is demountable and can collapse into a predetermined shape for ease of transport. The exemplary embodiment illustrated includes eight rectilinear fence sections that clip together and stand vertically in an octagonal pattern. The exemplary platform 12 is illustrated as having the similar pattern to match the pen wall 16. There can be various combinations of shapes and designs of pen wall 16 and platform 12.

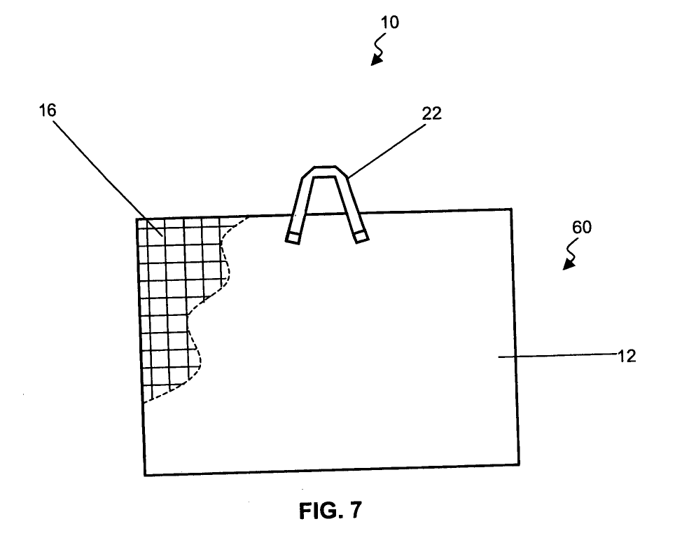

Referring to FIG. 7, an exemplary embodiment of the animal pen system 10 is illustrated. The animal pen system 10 is shown stored in a carrying case configuration (or carrying case enclosure) 60. The pen wall 16 is collapsed and stacked inside the body 12 such that the body 12 encloses the pen wall 16. The handle 22 is located on the bottom and exterior of the body 12 in the carrying case configuration 60. The body 12 and pen wall 16 can be deployed, if needed, by unfolding the body 12 and exposing the pen wall 16. With the carrying case configuration 60, the animal pen system 10 can be transported from one location to another and easily deployed to form the pen 58.

As an example, the animal pen system 10 can include a platform 16 that is shaped to match an eight sided pen wall 16. The pen wall 16 comprises eight individual panels having a fence material in a rectilinear shape. The base of each panel is flat. The pen wall 16 stands vertically upright to a distance of about 4 feet. One of the eight panels of the pen wall 16 functions as an entrance that can be latched closed. The platform 16 comprises a flexible cloth-like material, such as a canvas having water resistant treatment. The perimeter 24 of the platform 12 extends beyond the pen wall 16. The pen wall 16 is disposed on the platform 12. The wall portion 26 is coupled to the pen wall 16 near the base 28. Multiple coupling members 30 are coupled to the pen wall 16 with the hooks 32 and to the wall portion 26 with the cord 34. The wall portion 26 is cinched tightly to the pen wall 16. The pen wall 16 is prevented from sliding or moving along the top surface 18. The pen wall 16 and platform 12 enclose a pen 58 that allows for an animal, such as a dog, to be contained and prevented from damaging flooring, while maintaining freedom to move about and rest with minimal confinement. When the animal pen system 10 requires relocation, the animal is removed. The coupling members 30 are disconnected from the pen wall 16. The pen wall 16 is removed from the platform 12. The pen wall 16 is broken down, folded and stacked into a rectilinear stack. The platform 12 is folded along fold lines 56 and placed over the stack. The platform is secured, enclosing the pen wall 16 and forming a carrying case configuration 60. The handles 22 are manipulated so that the carrying case 60 can be transported.

The animal pen system 0I has the advantages of being adaptable to various pen wall 16 configurations. The animal pen system 10 can be transported and deployed over surfaces that are sensitive to animals, such as finished flooring. The animal pen system 10 can be dismantled and stowed away in a carrying case configuration 60 that is easily moved with little effort. The animal pen system 10 can be manufactured with durable abrasion resistant materials that also resist or repel moisture. The platform 12 of the animal pen system 10 can be formed into contours that contain liquids, such as urine, and prevent the spillage of such liquids onto the sensitive surfaces. Another advantage of the animal pen system 10 is that the system can be manufactured in a lightweight transportable configuration that can function to contain the animals in the pen without unduly restricting or inhumanly confining the animals.

While embodiments and applications of this disclosure have been shown and described, it would be apparent to those skilled in the art that many more modifications than mentioned above are possible without departing from the inventive concepts herein. The disclosure, therefore, is not to be restricted except in the spirit of the appended claims.

What is claimed is:

1. An animal pen system comprising:
a body having a top surface and a bottom surface opposite said top surface, said body being flexible, said body defining a support wall proximate a perimeter of said body, said support wall configured to support a pen wall disposed on said top surface of said body, wherein said support wall is configured to demountably couple to said pen wall.

2. The animal pen of claim 1 wherein said wall support at least partially encloses said pen wall proximate said perimeter.

3. The animal pen of claim 1 further comprising:
an attachment element coupled to said support wall and said pen wall.

4. The animal pen of claim 1 wherein said body comprises a flexible material.

5. The animal pen of claim 3 wherein said body comprises at least one mounting element configured to couple with said attachment element.

6. The animal pen of claim 5 wherein said coupling element comprises a cord including a hook disposed on a first end of said cord, wherein said hook is configured to demountably couple to said pen wall and said cord is configured to attach to said at least one mounting element at a second end of said cord.

7. The animal pen of claim 1 further comprising:
a handle formed in said body.

8. The animal pen of claim 1 wherein said body is configured to encase said pen wall and is configured to form a carrying enclosure for said pen wall.

9. The animal pen of claim 1 wherein said flexible body is configured to be foldable about at least one fold line.

10. The animal pen of claim 1 wherein said body is configured to be resistant to abrasion.

11. The animal pen of claim 1 wherein said body is configured to mount to a multisided animal pen.

12. An animal pen system comprising:
a pen platform having a top surface and a bottom surface opposite said top surface, said pen platform configured to fold along at least one fold line defined in said pen platform, said pen platform defining a wall portion, said wall portion extending from said top surface, said wall portion configured to enclose a pen wall about a base of said pen wall, said wall portion configured to extend along said pen wall;
a coupling element demountably coupled to said wall portion and said pen wall; and
at least one handle disposed on said bottom surface, wherein said pen platform is configured to encase said pen wall for transportation of said pen platform and said pen wall.

13. The animal pen of claim 12 wherein said pen platform comprises a flexible material, said flexible material being resistant to moisture.

14. The animal pen of claim 12 wherein said coupling element comprises a cord and hook disposed at a first end of said cord, said hook having a first receiver at a first end and a second receiver at a second end opposite said first end and a hook portion formed between said first receiver and said second receiver, said hook portion configured to attach to a wire mesh section along said pen wall.

15. The animal pen of claim 12 wherein said pen platform is configured with multiple discrete edges configured to align with an individual section of said pen wall, wherein said individual section of said pen wall is substantially planar.

16. The animal pen of claim 12 wherein said pen platform and said pen wall form a carrying case, said pen wall being contained within said pen platform.

17. The animal pen of claim 12 wherein said wall portion is configured to couple said pen wall to said top surface and is configured to prevent said pen wall from moving along said surface.

18. A method of using an animal pen system comprising:
deploying a pen platform having a top surface and a bottom surface opposite said top surface, said platform configured to fold along at least one fold line defined in said pen platform, said pen platform defining a wall portion formed from said pen platform, said wall portion extending from said top surface, said wall portion configured to enclose a pen wall about a base of said pen wall, said wall portion configured to extend along said pen wall;
mounting said pen wall to said top surface of said pen platform;
coupling said pen wall to said wall portion, wherein said wall portion encloses said pen wall about said base of said pen wall; wherein said pen wall is prevented from moving along said top surface.

19. The method of claim 18 wherein coupling said pen wall to said wall portion includes fastening a coupling element to said wall portion at a first end of said coupling element and hooking said coupling element to said pen wall.

20. The method of claim 18 further comprising:
encasing said pen wall in said pen platform;
folding said pen platform;
forming a carrying case from said pen platform with said pen wall encased in said pen platform, wherein said carrying case is deployable providing for the assembly of the animal pen system including said pen platform supporting said pen wall.
